(19) United States
(12) Patent Application Publication
(10) Pub. No.: US 2018/0367848 A1
(43) Pub. Date: Dec. 20, 2018

(54) METHOD AND SYSTEM FOR AUTO-VIEWING OF CONTENTS

(71) Applicant: Samsung Electronics Co., Ltd., Suwon-si, Gyeonggi-do (KR)

(72) Inventor: Sumit KUMAR, Noida (IN)

(21) Appl. No.: 15/781,853

(22) PCT Filed: Dec. 9, 2016
(86) PCT No.: PCT/KR2016/014475

§ 371 Date: Jun. 6, 2018

(30) Foreign Application Priority Data
Dec. 11, 2015 (IN) 4061/DEL/2015

(51) Int. Cl. H04N 21/442; H04N 21/4782; H04N 21/466

(52) U.S. Cl. CPC H04N 21/44222; H04N 21/4668; H04N 21/4667; H04N 21/4782

(57) ABSTRACT

The present invention relates to auto-viewing of contents. In accordance with one embodiment of the invention, an input for auto-viewing of contents is received. Upon receiving, a plurality of webpages based on one of the input, pre-stored rules, and an user interest are detected. Thereafter, information from at least one of the plurality of webpages is retrieved and a multimedia content is created based on the retrieved information for auto-viewing.

### CROSS-REFERENCE TO RELATED APPLICATION(S)

This application is a U.S. National Stage application under 35 U.S.C. § 371 of an International application number PCT/KR2016/014475, filed on Dec. 9, 2016, which is based on and claimed priority of an Indian patent application number 4061/DEL/2015, filed on Dec. 11, 2015, in the Indian Intellectual Property Office, the disclosure of which is incorporated by reference herein in its entirety.

### BACKGROUND

### 1. Field

The present invention generally relates content presentation, and, more specifically, to auto-viewing of contents over a network.

### 2. Description of the Related Art

In present times, computers and internet have become an integrated part of life of users. Users spend a lot of time sitting in front of computer while either working or surfing the internet. Consequently, users face many health issues due to bad sitting postures and focussing on screens of the computer for too long. Some common examples of such health issues include eyestrain, headaches, throbbing neck pain, pressure around sinuses and temples, clenched facial muscles, strained shoulders, itching and burning eyes, vision discomfort, flickering or flashing sensations, and blurred or double vision.

On the other hand, with the advent of technologies and convergence of internet with a lot of consumer device, smart devices have gained popularity. One such device is smart television or smart TV. Smart TV is a television or a set-top box integrated with internet. Smart TV enables users to retrieve information from the internet, shop for video/music/gaming products, access social media sites, and display multimedia files from other connected devices over the internet. Smart TV also allows users to download and access applications from an application store, in a manner similar to downloading of applications on a smart phone. Access to internet over the smart TV is enabled using various input methods such as remote controller, virtual keyboard, and voice commands.

However, surfing internet on smart TV needs lot of inputs or frequent inputs from the user. Additionally, the user spends a lot of time while surfing to get required content over internet. The time spent increases greatly when the user desires information related to different interests such as news, birthday gift, weather information, hotels, stock market, and movies. This again leads to health issues as mentioned above. Furthermore, information about such different interest from disparate sources is presented as different web pages which further needs to be browsed.

Various solutions are available which collate and present the information such that the surfing time is reduced. These solutions enable the user to view a multimedia presentation created from the collated information on the smart TV or a computer. In one solution, a slideshow is created by a server from multimedia contents such as images, audio, animation, and videos saved either at a location such a computing device or a social media networking site. In such solution, a user provides the location to a server via a client device. The server then copies the multimedia content present at the location, identifies attributes (e.g., geographical locations) to associate with the uploaded content, and automatically assembles a slideshow without any further input from the user. The server may also add other data such as maps, flags associated with the identified geographical locations, music, and passport stamps, and transition effect to the slideshow. The user can download the slideshow in a multimedia file format (e.g., Adobe Flash, Windows® Media, etc.), store it at the server (e.g., YouTube®), and/or sharing it with viewers. However, this solution requires sending a copy of the multimedia content to the server for creation of the slideshow. Moreover, the solution is limited to pre-stored content.

In another solution, a content-providing system collects items from a variety of sources. The items comprise images, videos, advertisements, articles, search results, emails, product specifications, sound recordings, texts, logos, slideshows, key words, graphic and/or text-based user interface components, and so on. Upon collecting, the content-providing system analyses browsing and searching behaviours of a large set or group of users and ranks the items by determining occurrences and frequencies of user accesses involving the items. Examples of such user accesses include, but not limited to, hit counts and search terms. Thereafter, the content-providing system acquires imagery and text data corresponding to the ranked items, establishes user-selectable items. The user-selectable items can be text based such as names of personalities, events, and geographic locations, and non-text based such as thumbnail of image, icon, well known mark, and easily recognized symbol. Subsequently, the content-providing system creates slideshow for the user-selectable items using the imagery and text data, incorporates advertisements in the slideshow, and saves the slideshow in a repository. The content providing system also stores profiles of users (who are browsing and searching information) in the repository such that the user-selectable=items are re-ranked based on the profiles. Subsequently, when a user makes a selection of a particular user-selectable item among the established user-selectable items while browsing and searching, the content-providing system determines whether the particular user-selectable term is associated with a slideshow in the repository. In response that a determination that the particular user-selectable term is associated with a slideshow, the content providing system provides an initial content item (e.g., slide) in the slideshow and one or more controls for navigation to the user. However, this solution provides a slideshow that has been pre-prepared and pre-stored based on group behaviours of large set of users. Such group behaviour may not cater to interests corresponding to single user and as such again lead to increased surfing time by the single user. Moreover, the slideshow is presented or displayed only if the user accesses an icon present next to an item pre-associated with the slideshow.

In one another solution, upon detecting a wireless device such as a smart phone is in ideal state, locally-stored media data such as images and videos, is added to a playlist for later playback by a slideshow application. The media data that is added can be selected based at least in part on context data, such as the time of day, user preferences, or previous user selections. Upon detecting the wireless device is connected to a charging device, the slideshow application automatically plays the playlist. Further, a determination is made if the wireless device is authenticated with an online media data provider. Upon positive determination, remotely-stored media data is either downloaded and added to the playlist or dynamically streamed into the playlist. The remotely-stored data can be images saved by a user of the wireless phone device who is authenticated on the online media data site and images saved by friend(s) of the user on the online media site. However, this solution only creates a slideshow of pre-stored images either locally on the wireless device or remotely with an online media data provider. This solution does not provide flexibility of surfing and searching contents other than the pre-stored images and present a slideshow accordingly.

In yet another solution, a search system is implemented in client-server architecture. The server hosts a web site that provides a form to accept queries and builds the index, parses queries, selects results, and generates a webpage comprising the results. The client runs software, such as a web browser, that provides a user interface to accept queries and displays the webpage comprising the results page via the web browser. The webpage comprising the results, which is generated by the server and displayed by the client, is formatted for the user's convenience. Each result in the webpage includes a text describing the indexed webpage and a hyperlink to that page, so that the user can evaluate each result and visit each webpage that matched the query. Further, the result may include a plurality of page indicators a page-button-like device that may link to a corresponding indexed webpage of the result. However, this solution necessitates a dependency on a server for obtaining a search result.

### SUMMARY

As can be gathered from above, the above-mentioned solutions do not provide much flexibility in terms of enabling the user to provide his different and/or unrelated interest with minimum interaction and reducing surfing time accordingly. Thus, there exists a need for a solution to overcome above-mentioned deficiencies.

In accordance with the purposes of the invention, the present invention as embodied and broadly described herein, provides a methods and systems for creating a multimedia content to enable auto viewing of contents over a network with minimum interaction and reduced surfing time. Accordingly, upon receiving user-input from at least one user for creation of a multimedia content, a plurality of webpages based on one of an interest corresponding to the at least one user and the user-input. The user-input includes at least one keyword, at least one image, at least one webpage, one or more tabs currently active on a web browser, duration of the multimedia content, schedule of viewing the multimedia content, transition effect in the multimedia content, transition time in the multimedia content, transition pace in the multimedia content, theme of multimedia content, content generation command, and a combination of thereof.

Thereafter, content is retrieved from the detected plurality of webpages and one or more portions is captured from the retrieved content of the plurality of webpages based on at least one of the interest corresponding to the at least one user, the user-input, and pre-stored rules. The interest corresponding to the at least one user includes browsing history, content viewing history, at least one pre-stored webpage, at least one keyword, and at least one pre-stored image.

The one or more captured portions of the plurality of webpages are collated based on a set of criteria and a multimedia content is created based on the collation. The set of criteria includes update time, the interest corresponding to the at least one user, priority, and un-visited content from the detected webpages. The multimedia content is a presentation comprising of at least one of text element, image element, video element, and audio element. Further, the multimedia content is auto played either on a web browser or on a multimedia content rendering application. Further, the multimedia content may include one or more of a transition element, a media element, authentication element, and a theme of content.

The advantages of the invention include, but are not limited to, providing an alternate and easy to use solution for surfing by converting contents on any webpages into a presentation or slideshow. As such, users would be able to surf with minimum interaction and yet obtain maximum output. Further, the solution provides flexibility to the user to provide his different and/or unrelated interest with minimum interaction and auto view the contents based on the different and/or unrelated interest over a network in the form of a slideshow. As such, health issues due to bad sitting postures and focussing on screens of the computer for too long are reduced.

Further, as the content is retrieved and collated based on many criteria, the accuracy of retrieval of information is ensured in accordance with user's interest, freshness of content, and browsing patterns. Furthermore, a lot of overheads such as lot of clicks, next, back, and need of uninterruptable attention are eliminated. This greatly reduces surfing time and provides a relaxed browsing experience. Additionally, user's time is saved as the slideshow enables the user to possess lot of information in very less time.

These aspects and advantages will be more clearly understood from the following detailed description taken in conjunction with the accompanying drawings and claims.

### BRIEF DESCRIPTION OF THE DRAWINGS

To further clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings, which are listed below for quick reference.

FIG. 1 illustrates flow chart of a method for auto viewing of contents, in accordance with an embodiment of the present invention.

FIG. 2 illustrates flow chart of a method for creating a multimedia content, in accordance with an embodiment of the present invention.

FIG. 3 illustrates an exemplary computing device implementing the methods as described in FIGS. 1 and 2, in accordance with an embodiment of the present invention.

FIG. 4 illustrates a further detailed computing device implementing the methods as described in FIGS. 1 and 2, in accordance with an embodiment of the present invention.

FIG. 5 illustrates a screenshot of a webpage for implementing the methods as described in FIGS. 1 and 2, in accordance with an embodiment of the present invention.

FIG. 6 illustrates a screenshot of a user-interface for implementing the methods as described in FIGS. 1 and 2, in accordance with an embodiment of the present invention.

FIGS. 7(a) to 7(e) illustrate screenshots corresponding to a first exemplary manifestation depicting the implementation of the invention.

FIGS. 8(a) and 8(b) illustrate screenshots corresponding to a second exemplary manifestation depicting the implementation of the invention.

FIG. 9 illustrates screenshot of a multimedia content corresponding to the first and second exemplary manifestations depicting the implementation of the invention.

FIG. 10 illustrates a typical hardware configuration of a computing device, which is representative of a hardware environment for practicing the present invention.

### DETAILED DESCRIPTION

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

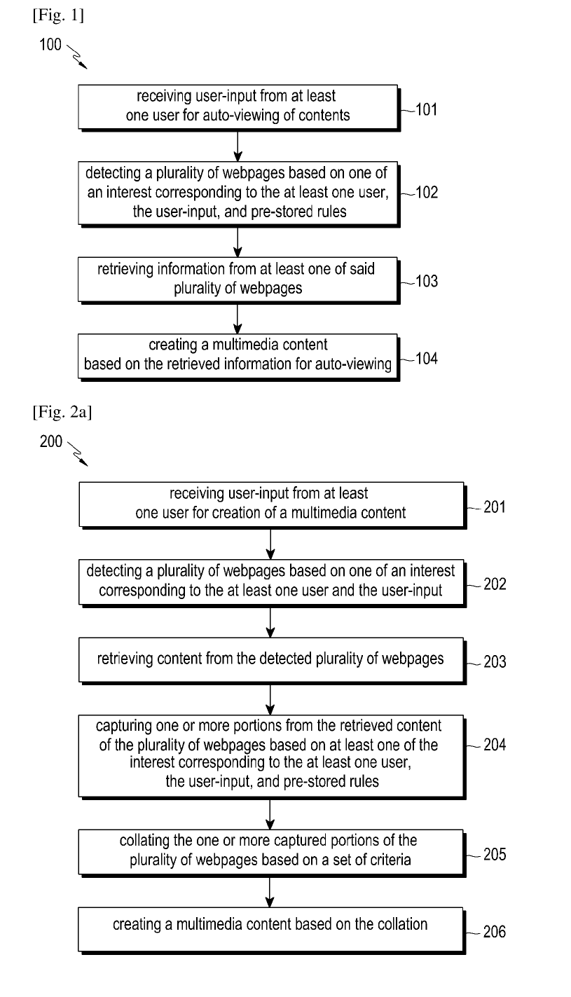

Referring to FIG. 1, there is illustrated an exemplary method (100) for auto-viewing of contents, the method (100) comprising: receiving (101) user-input from at least one user for auto-viewing of contents; detecting (102) a plurality of webpages based on one of an interest corresponding to the at least one user and the user-input; retrieving (103) information from at least one of said plurality of webpages; and creating (104) a multimedia content based on the retrieved information for auto-viewing.

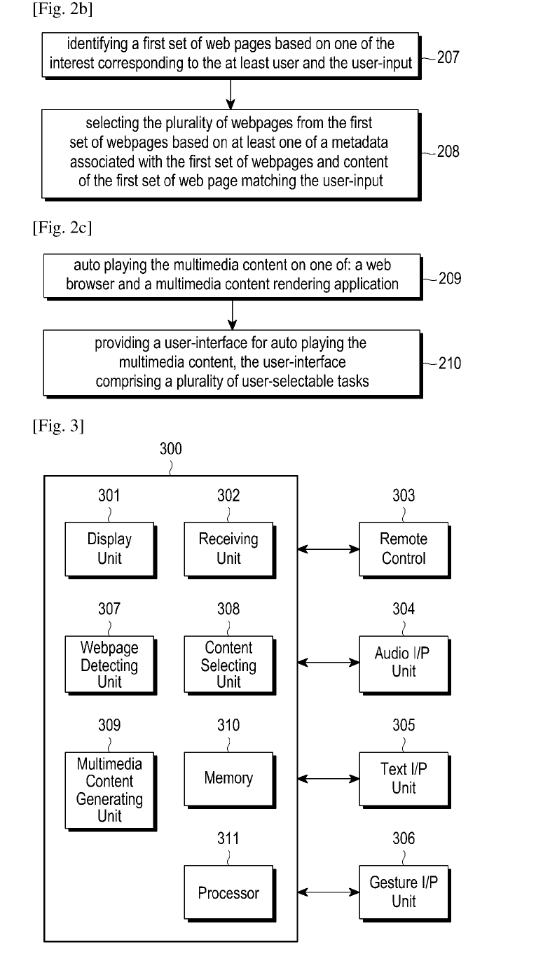

Referring to FIG. 2, there is illustrated an exemplary method (200) creating a multimedia content, in accordance with an embodiment of the invention. In such embodiment, as illustrated in FIG. 2a, the method (200) comprises the steps of: receiving (201) user-input from at least one user for creation of a multimedia content; detecting (202) a plurality of webpages based on one of an interest corresponding to the at least one user and the user-input; retrieving (203) content from the detected plurality of webpages; capturing (204) one or more portions from the retrieved content of the plurality of webpages based on at least one of the interest corresponding to the at least one user, the user-input, and pre-stored rules; collating (205) the one or more captured portions of the plurality of webpages based on a set of criteria; and creating (206) a multimedia content based on the collation.

Further, the user-input includes one or more of: at least one keyword, at least one image, at least one webpage, one or more tabs currently active on a web browser, duration of the multimedia content, schedule of viewing the multimedia content, transition effect in the multimedia content, transition time in the multimedia content, transition pace in the multimedia content, theme of multimedia content, content generation command and a combination of thereof.

Further, the user-input is received via one of: input device, non-touch gesture input, a touch gesture input, a voice input, and a text input.

Further, as illustrated in FIG. 2b, the step of detecting (202) further comprises the steps of: identifying (207) a first set of web pages based on one of the interest corresponding to the at least user and the user-input; and selecting (208) the plurality of webpages from the first set of webpages based on at least one of a metadata associated with the first set of webpages and content of the first set of webpage matching the user-input.

Further, the metadata associated with a webpage includes: page rank of the web page, importance of the web page, comments posted on the web page, count of hits on the web page, count of likes on the web page, rating of the web page, and rating of content available on the web page.

Further, the interest corresponding to the at least one user includes one or more of: browsing history, content viewing history, at least one pre-stored webpage, at least one keyword, and at least one pre-stored image.

Further, the browsing history includes one or more of: most-visited webpages, recently visited webpages, and corresponding extended webpages.

Further, the content viewing history includes one or more of: most-viewed content, last visited content, least visited content, unread content from the detected webpages, and un-visited content from the detected webpages.

Further, the set of criteria includes one or more of: update time, the interest corresponding to the at least one user, priority, and un-visited content from the detected webpages.

Further, the set of criteria further includes interest corresponding to plurality of users, predefined order of interest corresponding to the plurality of users, predefined percentage allocation of interest corresponding to plurality of users, the plurality of users including the at least one user, and wherein the interest corresponding to the plurality of users includes one or more of: a combination of interest corresponding to each of the plurality of users, a combination of common interest corresponding to the plurality of users, and a selection of interest corresponding each of to the plurality of users.

Further, the one or more portions are captured based on one or more of: size of a display unit displaying the multimedia content, viewing distance of the at least one user from the display unit, font size of content of a web page, viewing position of the at least one user, probability of visibility of content of a webpage from a viewing position of the at least one user, and further user input from the at least one user.

Further, the step of creating (206) the multimedia content further comprises one or more of: adding at least one transition element to the multimedia content; adding at least one media element to the multimedia content; adding a authentication element to the multimedia content; and applying a theme of content to the multimedia content.

Further, the method (200) comprises storing the multimedia content.

Further, as illustrated in FIG. 2c, the method (200) comprises the step of auto playing (209) the multimedia content on one of: a web browser and a multimedia content rendering application.

Further, as illustrated in FIG. 2c, for auto playing, the method (200) comprises the step of providing (210) a user-interface for auto playing the multimedia content, the user-interface comprising a plurality of user-selectable tasks.

Further, the multimedia content is a presentation comprising of at least one of text element, image element, video element, and audio element.

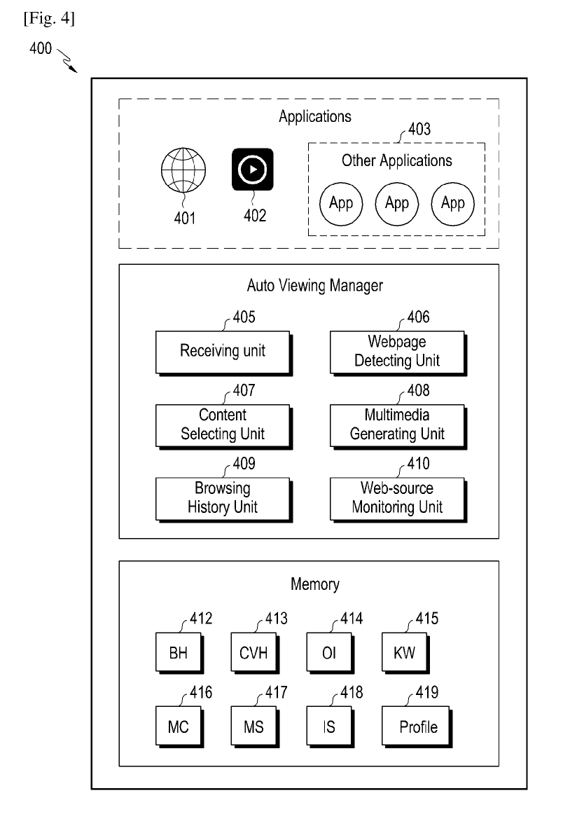

As illustrated in FIG. 3, the present invention further provides a computing device (300) implementing the aforesaid methods as illustrated in FIGS. 1 & 2 in accordance with an embodiment. Examples of the computing device (200) include smart television (TV), set-top box coupled with a display unit such as projector, smart phone, laptop, and tablet. In such embodiment, the computing device (300) includes display unit (301) adapted to depict various elements such as images, texts, and videos. Examples include, but not limited to, depicting a list of applications available on the computing device (300), depicting user-interface corresponding to each of the applications available in the computing device (300), and depicting various features of the computing device (300).

According to the present invention, the computing device (300) implements methods, as described in FIGS. 1 & 2 above, for auto viewing of contents over a network to reduce surfing time and provide relaxed browsing experience. As such, the computing device (300) further includes a receiving unit (302) adapted to receive user-input from at least one user for auto-viewing of contents. The receiving unit (302) can receive the user-input from a variety of input devices communicatively coupled with the computing device (300). The input devices include a remote controller (303), an audio input device (304), a text input device (305), and a gesture input device (306). Examples of the text input device (305) include a virtual keyboard application available in the computing device (300) and a physical keyboard communicatively coupled to the computing device (300). In one aspect of the invention, the user-input can be provided through any one of the input devices. In another aspect of the invention, the user-input can be provided via a combination of the input devices.

Further, the computing device (300) further includes a webpage detecting unit (307) communicatively coupled to the receiving unit (302). Upon receiving the user-input, the webpage detecting unit (307) is adapted to detect a plurality of webpages based on at least one of an interest corresponding to the at least one user, the user-input, and pre-stored rules.

Further, the computing device (300) includes a content selecting unit (308) coupled to the webpage detecting unit (307) to retrieve information from at least one of the detected plurality of webpages. Further, the computing device (300) includes a multimedia content generating unit (309) coupled to the content selecting unit (308) adapted to create a multimedia content based on the retrieved information for auto-viewing. Upon creating the multimedia content, the multimedia content generating unit (309) displays or plays the multimedia content for auto-viewing on the display unit (301). In one aspect of the invention, the multimedia content generating unit (309) auto-plays the multimedia content on a web browser application available on the computing device (300). In another aspect, the multimedia content generating unit (308) auto-plays the multimedia content on a multimedia content rendering application available on the computing device (300).

In another embodiment, the content selecting unit (308) is further adapted to retrieve content from the detected plurality of webpages. The content selecting unit (308) is further adapted to capture one or more portions from the retrieved content of the plurality of webpages based on at least one of the interest corresponding to the at least one user, the user-input, and pre-stored rules. Thereafter, the multimedia content generating unit (309) is further adapted to collate the one or more captured portions of the plurality of webpages based on a set of criteria. The multimedia content generating unit (309) is further adapted to create a multimedia content based on the collation.

Further, the computing device (300) includes a memory (310) coupled to the above-mentioned units. In one aspect of the invention, the multimedia content generating unit (309) stores the created multimedia content in the memory (310) for later viewing. The memory (310) may further include other data as necessary.

Further, the computing device (300) includes a processing unit (311) adapted to perform necessary functions of the computing device (300) and to control the functions of the above-mentioned units of the computing device (300).

It would be understood that the computing device (300), the display unit (301), the receiving unit (302), and the processing unit (311) may include various hardware modules/units/components or software modules or a combination of hardware and software modules as necessary for implementing the invention.

Further, the webpage detecting unit (307), the content selecting unit (308), and multimedia content generating unit (309) can be implemented as hardware modules or software modules or a combination of hardware and software modules. In one aspect of the invention, the webpage detecting unit (307), the content selecting unit (308), and the multimedia content generating unit (309) can be implemented as different entities, as depicted in the figure. In another aspect of the invention, the webpage detecting unit (307), the content selecting unit (308), and multimedia content generating unit (309) can be depicted as single entity performing the functions of webpage detecting unit (307), the content selecting unit (308), and multimedia content generating unit (309).

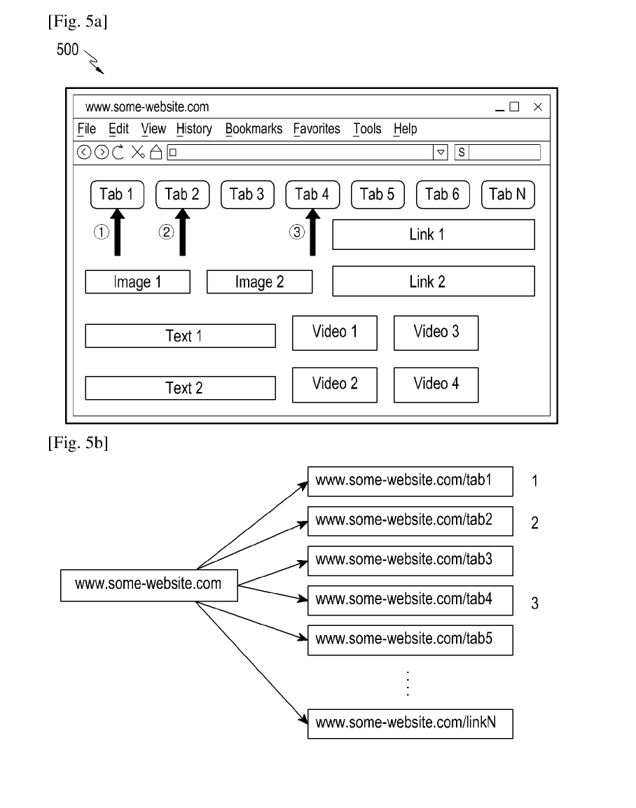

For the ease of understanding, the forthcoming descriptions of FIGS. 4-9 illustrate implementation of the methods as described in reference to FIGS. 1 & 2 above. Accordingly, FIG. 4 illustrates an exemplary computing device (400) comprising further components in addition of the unit/components as described in reference to FIG. 3 above for implementing the methods.

In accordance with the embodiment, the computing device (400) provides a relaxed browsing experience by reducing surfing time. Accordingly, the computing device (400) includes one or more web browsing applications (401) and one or more multimedia content rendering application (402). For the sake of brevity, only one web browsing application and one multimedia content rendering application is depicted. In addition, the computing device (400) includes other applications (403) designed to provide various services/functionality to a user, with or without accessing data via a network. Examples of the applications include, but not limited to, music application, chat applications, mail applications, browser applications, messaging applications, e-commerce applications, social media applications, data based media applications, location-based service (LBS) applications, print/scan/fax applications, and search applications. Such applications can be either downloaded onto the computing device (400) or preloaded in the computing device (400).

Further, the computing device (400) includes an auto-view manager (404) for enabling auto-viewing of contents to provide a relaxed browsing experience by reducing surfing time. The auto-view manager (404) includes a receiving unit (405), a webpage detecting unit (406), a content selecting unit (407), and a multimedia content generating unit (408), as described in reference to FIG. 3. The auto-view manager (404) further includes browsing history unit (409) and a web-source monitoring unit (410). In one aspect of the invention, the auto-view manager (404) and corresponding units are implemented as software modules. In one example, the auto-view manager (404) can be downloaded onto the computing device (400). In another example, the auto-view manager (404) can be preloaded onto the computing device (400) at the time of manufacturing by a manufacturer of the computing device (400). In another aspect of the invention, the auto-view manager (404) and corresponding units are implemented as hardware modules. In one another aspect of the invention, the auto-view manager (404) and corresponding units are implemented as combination of hardware and software modules.

Further, the browsing history module (409) tracks browsing patterns of one or more users surfing the internet through the web based application (401) and saves a browsing history in a memory (411) as browsing history (BH) (412). The browsing history (412) includes information about most-visited webpages, recently visited webpages, and corresponding extended webpages. As would be understood, the corresponding extended webpages are web pages linked within a web page.

Similarly, the web-source monitoring unit (410) monitors pre-visited webpages and corresponding extended webpages recursively and detects content viewing patterns. Based on the detection, the web-source monitoring unit (410) saves a content viewing history in the memory (411) as content viewing history (CVH) (413). The content viewing history (413) includes, but not limited to, most-viewed content, last visited content, least visited content, unread content from the webpages, new content, and un-visited content from the webpages.

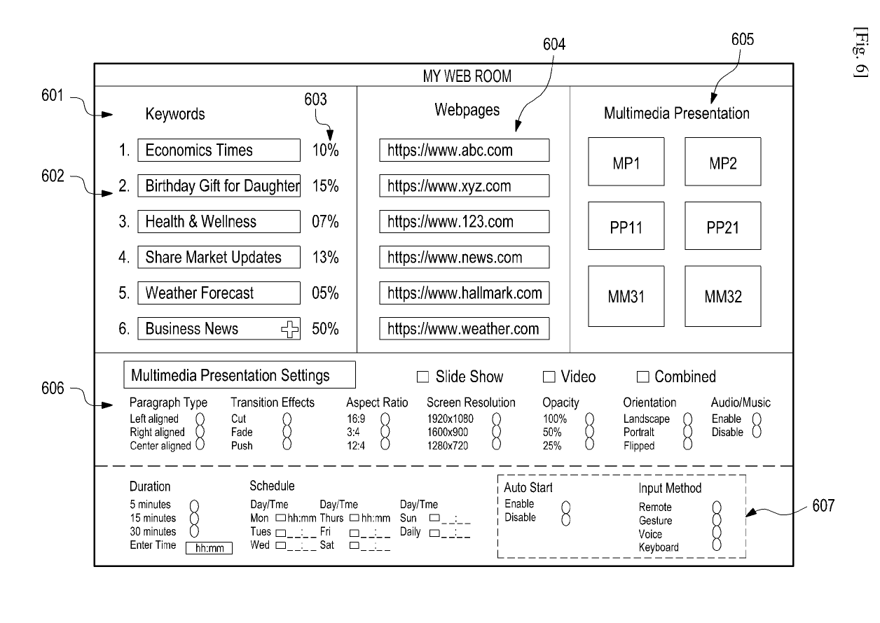

In one aspect of the invention, the web-source monitoring unit (410) maintains a tree structure to maintain the content viewing history (413) about the extended webpages linked with a webpage. FIG. 5 illustrates screenshot of a webpage for maintaining a tree structure for a webpage. Accordingly, FIG. 5a illustrates an exemplary webpage (500) being tracked by the browsing history module (409). The webpage (500) includes a plurality of tabs such as Tab1, Tab 2, Tab 3, Tab 4, Tab 5, Tab 6, and Tab N. The plurality of tabs indicates links to extended webpages within the webpage (500). For example, the webpage (501) can be a homepage of an online newspaper and the tabs provide links to different sections of the online newspaper such as weather, sports, lifestyle, world news, domestic news, entertainment, travel, blogs, photos, and videos.

The webpage (500) further includes various webpage elements such as videos, text, static images animated images, hyperlinks or navigational elements to other portions of webpage, and data files linked through hyperlinks. The webpage (500) further includes one or more links in addition to the plurality of tabs. The links are uniform resource locator (URL) pointing to other webpages. In addition, the videos and images on the webpage (500) may further be associated with links such that clicking on the videos and the images, renders a new webpage associated with the links.

In an example, a user clicks on Tab1 often and reads/views the content in the Tab1 often, represented by an arrow and numeral 1. Similarly, the user clicks on Tab2 and Tab4 less often than Tab1 and reads/views the content, represented by arrows and numerals 2 & 3 respectively. As depicted in FIG. 5b, the web-source monitoring unit (410) creates a tree structure (501) for the webpage (500) and maintains the content viewing history accordingly. Thus, by considering depth of each of the webpage being browsed, the interest of the user can be more accurately tracked and used for creating a multimedia content.

Now referring to FIG. 4 again, the receiving unit (405) receives an input for creation of a multimedia content from a user. The input can be at least one keyword, at least one image, at least one webpage, and one or more tabs currently active on the web browser application (401). The receiving unit (405) receives the input from one input device communicatively coupled with the computing device (400) or a combination input devices communicatively coupled with the computing device (400).

The input can be multimedia presentation settings such as duration of the multimedia content, schedule of viewing the multimedia content, transition effect in the multimedia content, transition time in the multimedia content, transition pace in the multimedia content, and theme of multimedia content. The input can be keywords, images, webpages, and one or more tabs currently active on the web browsing application (401).

Accordingly, the auto-viewing manager (401) provides a user-interface for providing the input. In one aspect of the invention, the user-interface can be provided on a display unit of the computing device (400) upon receiving a corresponding input from the user. In another aspect of the invention, the multimedia presentation settings can be provided at the time of creation of the multimedia content.

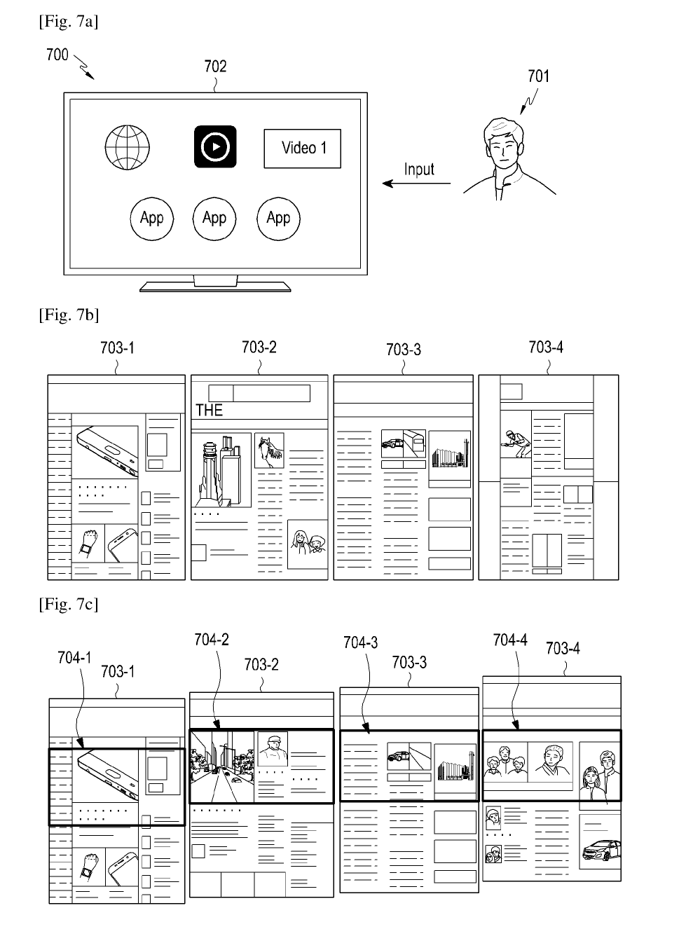

Accordingly, FIG. 6 illustrates a screenshot of the user-interface (600) for providing the input. Example of such user-interface includes a web room provided by a third party or manufacture of the computing device (400). The user-interface (600) includes a keyword panel (601) for providing one or more keywords. The keyword panel (601) includes text fields for inputting one or more keywords via audio input device and/or keyboard. The keyword panel (601) further includes an order (602) of the text fields and a percentage allocation of the interest (603) for the text fields. The user can change the order (602) of the text fields and the percentage allocation of the interest (603) for the text fields, thereby changing a priority of the keywords. Such order and percentage allocation of the interest can be saved in memory (411) as data corresponding to order and interest (OI) (414).

In a similar manner, the user-interface (600) includes a webpage panel (604) for providing one or more webpages. The webpage panel (604) includes text fields for inputting one or more keywords via audio and keyboard. The keywords and the webpages provided through the keyword panel (601) and the webpage panel (604) can be saved in the memory (411) as data corresponding to keywords and webpages (KW) (415).

Further, the user-interface (600) includes a multimedia panel (605) for displaying multimedia content prepared earlier and stored in the memory (411) as data corresponding to multimedia content (MC) (416). For the sake of illustration, the multimedia content prepared earlier as depicted as MP1, MP2, PP11, PP12, MM31, and MM32 in the figure.

Further, the user-interface (600) includes multimedia presentation settings panel (606) for selecting multimedia presentation settings. Through the multimedia presentation settings panel (606), the user can select creation of multimedia content in slideshow mode, video mode, or combined mode; alignment of paragraph; addition of transition effects; duration of the multimedia content; schedule of the multimedia content; enablement of audio/music; and display settings like aspect ratio, screen resolution, opacity, and orientation. The selection can be saved in in the memory (411) as multimedia settings (MS) (417).

Further, the user-interface (600) includes input settings panel (607) for selecting an input method and enable auto-start mode. As such, the user can select an input device such as remote controller, an audio input device, a text input device, and gesture based input device, for providing an input. The auto-start mode can be enabled for creation of the multimedia content without receiving input from the user. Such selection can be saved in the memory (411) as input settings (IS) (418).

Through the user-interface (600), different users can provide their interests. As such, a profile is created for each of the user accessing the user-interface (600) and saved in the memory (411) as data corresponding to profile (419). Thus, the profile (419) includes information corresponding to browsing history, content viewing history, keywords, webpages, and images, specific to a user. In one aspect of the invention, each profile (419) of a user is mapped with a biometric identification of the user such that when the presence of the user is detected, the profile is selected. Examples of the biometric identification include face and voice.

Now referring to FIG. 4 again, upon receiving the input, the webpage detecting unit (306) detects a plurality of webpages based on at least one of an interest corresponding to the user, the received input, and pre-stored rules. The interest corresponding to the user includes browsing history, content viewing history, at least one pre-stored webpage, at least one keyword, and at least one pre-stored image. The pre-stored rules correspond to one or more of font size and importance of portion of webpages. The user can configure the pre-stored rules during initial settings of the auto-viewing manager (404). The font size indicates a preference for size of text with respect of size of the display unit such that webpages can be detected suitable for the size of the display unit. Similarly, the importance of portion of webpages indicates a preference for specific content. In an example, the user can store ‘advertisement’ and ‘headlines’ as pre-stored rules. Accordingly, webpages will be detected which include ‘advertisement’ and ‘headlines’. Thus, by considering pre-stored rules, the interest of the user can be more accurately tracked and used for creation of a multimedia content.

Accordingly, the webpage detecting unit (406) communicates with the browsing history module (409) and the web-source monitoring unit (410) to obtain the browser history (411) and the content viewing history (413) from the memory (411). Further, the webpage detecting unit (406) detects or recognizes the user based on biometric information such as face and voice. AS would be understood, the webpage detecting unit (406) may communicate with a biometric input unit available in the computing device (400) to receive the biometric information and detect the user. Upon detecting the user, the webpage detecting unit (406) obtains the profile (419) corresponding to the user from the memory (411). Upon obtaining the profile (419), the webpage detecting unit (406) determines interest corresponding to the user. Accordingly, the webpage detecting unit (406) fetches the data corresponding to order and interest (414), data corresponding to keywords and webpages (415), and data corresponding to multimedia content (416) from the memory (411) to determine the interest.

In a similar manner, the webpage detecting unit (406) determines interest of plurality of users upon detecting presence of plurality of users. Such determination of interest of plurality of users is based on a determination criterion such as combination of all interest(s), combination of common interest(s), and selection of particular interest(s). In one example, the interest of plurality of users is a combination of interest corresponding to each of the plurality of users. In another example, the interest of plurality of users is a combination of common interest corresponding to the plurality of users. In yet another example, the interest plurality of users is a selection of interest corresponding each of to the plurality of users. In one aspect of the invention, the user can predefine the determination criterion during initial settings of the auto-viewing manager (404).

Upon determining the interest corresponding to the user, the webpage detecting unit (406) identifies a first set of web pages based on the interest corresponding to the user, the input, and the pre-stored rules. Upon identifying, the webpage detecting unit (406) selects a plurality of webpages from the first set of webpages based on at least one of a metadata associated with the first set of webpages and content of the first set of webpage matching the user-input. The metadata associated with a webpage includes, but not limited to, page rank of the web page, importance of the web page, comments posted on the web page, count of hits on the web page, count of likes on the web page rating of the web page, and rating of content available on the web page. Thus, the metadata indicates a measure of popularity of the web page.

Upon detecting plurality of web pages, the content selecting unit (407) retrieves content from the detected plurality of webpages. In one aspect of the invention, if interest corresponding to the user is unavailable or not predefined by the user, the content selecting unit (407) retrieves the content from the first of webpages in a sequential order of detection of the first set of webpages. Upon retrieving, the content selecting unit (407) captures one or more portions from the retrieved content of the plurality of webpages based on at least one of the interest corresponding to the at least one user and the input. In one aspect of the invention, the content selecting unit (407) takes a screenshot of frame of the plurality of the webpages. In another aspect of the invention, the content selecting unit (407) selects one or more portions from the retrieved content based on the interest corresponding to the user and the input. Upon selecting, the content selecting unit (407) transmits a request for content from the selected portions to the web browser application (401). Upon receiving the request, the web browser application (401) identifies location of the selected portions based on a render tree created for each of the plurality of the webpages, as known in the art.

For the sake of brevity and for the ease of understanding, the process is briefly described here. Accordingly, a web engine of the web browser application (401) parses a data file such as HTML file and XML file corresponding to a webpage and creates a parse tree or a data object model (DOM) tree. The DOM tree provides a hierarchy of webpage elements of the webpage in the form of nodes. Each node also holds other properties specific to the corresponding element of the webpage. Thereafter, the web engine parses style attributes and combines with the DOM tree to create a render tree. The render tree orders visual components of the webpage elements such as height, width, and colour in the hierarchy in which they are to be displayed in the web browser application. Upon creation of the render tree, the web engine recursively traverses through the nodes in the render tree to determine a location of the selected portions. Upon determination, the web engine obtains the nodes at the determined location and provides information at the nodes to the content selecting unit. The web engine also provides information about relevant properties of each of the identified nodes.

Further, the webpage may include links to other web pages that might hold relevant information related to content on the web page. Upon encountering such links in the data file, the web engine loads or launches each of the links in background and extracts information. The web engine then summarises information in the DOM tree as described above. Similarly, information related to properties and style attributes corresponding to the information is added. Thus, the web engine obtains the information from the other web pages and provides to the content selecting unit. This entire process is repeated for each of the plurality of web pages.

Further, the content selecting unit (407) selects the content from the detected webpages, including the extended webpages, based on duration of playing the multimedia content. The duration of playing the multimedia content can be provided as an input for creation of the multimedia content or can be saved earlier as multimedia settings (417) in the memory (411). In an example, the duration of playing the multimedia content is 5 minutes. In such example, the content selecting unit (407) selects the content sufficient for creating a slideshow with 50 slides to present the multimedia content. Additionally, the content selecting unit (407) selects the content in accordance with network speed. In the above example, the content selecting unit (407) selects the content such that the number of slides is increased according to network speed. In one aspect of the invention, selection of content can be initiated in accordance with duration of viewing and schedule of viewing the multimedia content. In an example, the duration of playing the multimedia content is 5 minutes and schedule of viewing the multimedia content is 1700 hrs. In such example, the content the process of detecting webpages and selecting contents is initiated at 1655 hrs.

Furthermore, the content selecting unit (407) selects the content from the detected webpages, including the extended webpages, based on size of the display unit, font size of the content, resolution of the content (for example, image resolution), and viewing parameters with respect to the display unit. The viewing parameters include, but not limited to, viewing distance of the user from the display unit, viewing position of the user, and probability of visibility of the content from the viewing position of the user. This enables selection and subsequent presentation of the multimedia content in a manner that lessens physiological strain on the user.

Upon obtaining the content and the relevant information about the content, the content selecting unit (407) provides the content and the relevant information about the content to the multimedia content generation unit (408). The multimedia content generation unit (408) collates the captured portions or the content based on a set of criteria. The set of criteria includes, but not limited to, update time, the interest corresponding to the at least one user, priority, and un-visited content from the detected webpages. As would be understood, the update time of the web page indicates time at which contents and other aspects of the web page are modified. Such an update time is useful for ascertaining freshness of content in accordance with user input and interest corresponding to the user. As such, the multimedia content generation unit (408) fetches the browsing history (412) and the content viewing history (413) stored in the memory (411) to determine the set of criteria.

Further, the set of criteria includes interest corresponding to plurality of users, as determined by the webpage detecting unit (406). Furthermore, the set of criteria includes predefined order of interest corresponding to the plurality of users and predefined percentage allocation of interest corresponding to plurality of users. As such, the multimedia content generation unit (408) fetches the data corresponding to order and interest (414) stored in the memory (411) to determine the set of criteria. Further, the set of criteria may also include predefined arrangement of content. The arrangement of content can be either serial or shuffled in accordance with the interest corresponding to the user. In an example, the predefined arrangement of content can serial. In such example, the content is arranged serially in the order of their selection by the content selecting unit (407). In another example, the predefined arrangement of content can shuffle. In such example, the content is shuffled with the interest corresponding to the user and then arranged. The user can configure the predefined arrangement of content during initial settings of the auto-viewing manager (404)

Upon collating the contents, the multimedia content generating unit (408) creates a multimedia content from the contents and chooses a theme for the multimedia content. The multimedia content can include one or more of text element, image element, video element, and audio element. In one aspect of the invention, the theme for the multimedia content is chosen based on the interest corresponding to the user. In another aspect, the theme for the slideshow is chosen based on the content. The multimedia content can include a combination of text, videos, and images. In one aspect of the invention, the selection of content and creation of the multimedia content is performed in parallel. In such aspect, a notification can be provided to the user on the display unit indicating ongoing process of selection of content and creation of the multimedia content. This enables a quick response to the input provided by the user for creation of the multimedia content.

Upon creating, the multimedia content generating unit (408) arranges the multimedia content in a presentation format such as slideshow. In an example, each image, video, text is arranged in individual slide of the slideshow. In addition, the multimedia content generating unit (408) arranges the multimedia content based on the content itself. In an example, a story line can be created based on history or background of a topic present in the content. Thereafter, the multimedia content generating unit (408) adds transition element to the multimedia content to emphasize latest content in the slideshow or give a particular treatment to content with similar subject matter.

Additionally, the multimedia content generating unit (408) adds media element to the multimedia content. The media element is then played in parallel to the rendering of the multimedia content. In an aspect of the invention, the media element can be fetched from memory (411). In an example, a music file can be fetched from the memory (411) and added to the media content. In other aspect of the invention, the media element can be fetched from the multimedia content itself. In an example, text of the content can converted to an audio or speech and added to the multimedia content.

In addition, the multimedia content generating unit (408) adds an authentication element to the multimedia content to prevent unauthorized access. Examples of the authentication element include voice based passcode/passwords, text based passcode, gesture based passcode, and non-gesture based passcode.

Upon adding various elements as mentioned above, the multimedia content generating unit (408) provides plurality of user-selectable tasks on the multimedia content. Examples of the user-selectable tasks include scroll, navigation between slides, volume, full screen, and mark contents. In addition, the multimedia content generating unit (408) adds fabricated menu to the multimedia content based on contents of the plurality of the webpages.

Upon creation of the multimedia content, the multimedia content generating unit (408) exports the multimedia content to the web browser application (401) for rendering the multimedia content through the web browser application (401). In an example, the multimedia content is rendered as a slideshow. In one aspect of the invention, the multimedia content generating unit (408) renders the slideshow immediately upon creation. In another aspect of the invention, the multimedia content generating unit (408) provides a notification message on the display unit indicating creation of the slideshow and renders the slideshow upon receiving corresponding instructions from the user.

Further, the multimedia content generating unit (408) stores the multimedia content in the memory (411) as the multimedia content (416) for future references or later viewing. Additionally, the multimedia content generating unit (408) allows sharing of the multimedia content via data sharing applications available on the computing device (400). Examples of the data sharing applications include social media application, email application, and media sharing applications.

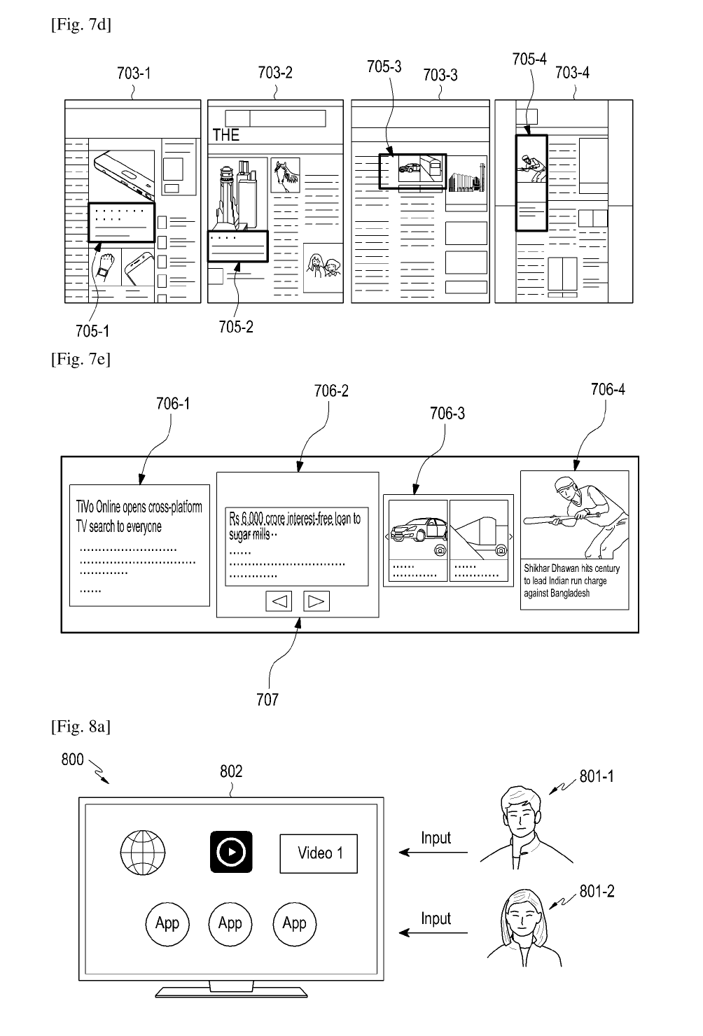

FIG. 7 schematically illustrates process (700) of creation of multimedia content based on input from a single user.

FIG. 7a illustrates a user (701) sitting in front of a computing device (702). The computing device (702) includes a web browser application, a multimedia rendering application, other applications, and other elements such as text, video, images, and audio. According to embodiment of the invention, the user (701) gives input to the computing device (702). In one aspect of the invention, the input can be keywords, images, links of webpages, and multimedia presentation settings. In another aspect of the invention, the input can be a content generation command. In such aspect of the invention, the computing device (702) can detect the user (701) and obtain a profile of the user from the memory. As described earlier, the profile includes interest of the user, multimedia settings pre-stored by the user.

Upon receiving the input, the computing device (702) detects a plurality of webpages based on the interest corresponding to the user and the input and retrieves content from the detected plurality of webpages. Accordingly, FIG. 7b illustrates four web pages 703-1, 703-2, 703-3, and 703-4 detected by the computing device (702). Upon retrieving the content, the computing device (702) captures one or more portions from the retrieved content of the plurality of webpages based on the interest corresponding to the user and the user-input. Accordingly, FIG. 7c illustrates selection of portions on 704-1, 704-2, 704-3, and 704-4 the corresponding detected webpages 703-1, 703-2, 703-3, and 703-4; and FIG. 7d illustrates capturing of contents 705-1, 705-2, 705-3, and 705-4 more precisely in the selected portions 704-1, 704-2, 704-3, and 704-4, as described earlier.

Upon capturing, the computing device (702) collates the captured portions of the plurality of webpages based on a set of criteria and creates a multimedia content based on the collation. In addition, the computing device (702) adds plurality of user-selectable task to the multimedia content. Accordingly, FIG. 7e illustrates a multimedia content presented as a slideshow (706) having user-selectable tasks (707). Each slide (706-1, 706-2, 706-3, and 706-4) of the slideshow (706) corresponds to each of captured portions (705-1, 705-2, 705-3, and 705-4) from the detected webpages (703-1, 703-2, 703-3, and 703-4).

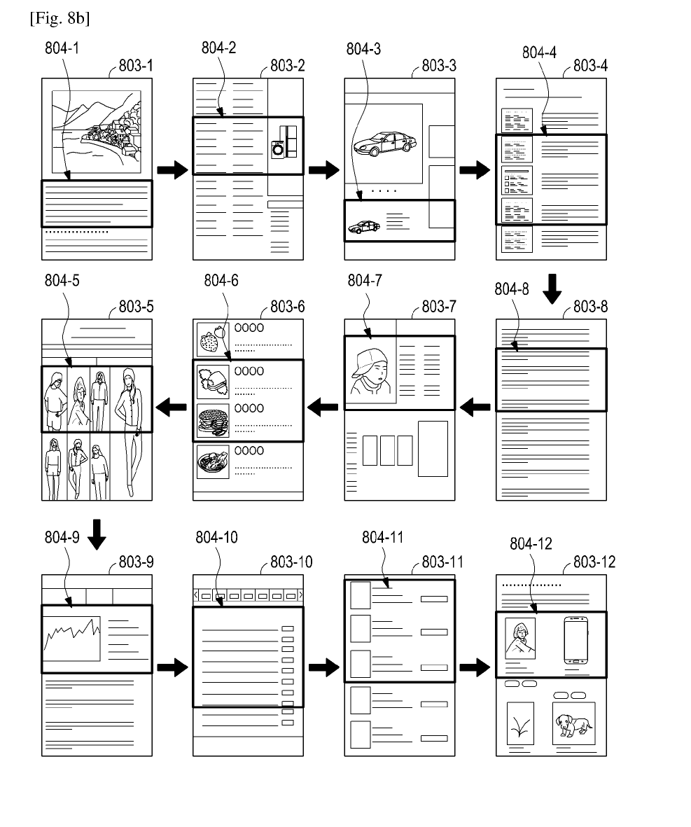

FIG. 8 schematically illustrates process (800) of creation of multimedia content based on input from two users. It would be understood that the principles of invention would remain same even if more than two users were providing the input.

FIG. 8a illustrates two users (801-1, 801-2) sitting in front of a computing device (802). The computing device (802) includes a web browser application, a multimedia rendering application, other applications, and other elements such as text, video, images, and audio. According to embodiment of the invention, the users (801-1, 801-2) give input to the computing device (802). In one aspect of the invention, the input can be keywords, images, links of webpages, and multimedia presentation settings provided by the two users (801-1, 801-2). In such aspect, either of the users or both the users can give the input. In another aspect of the invention, the input can be a content generation command provided by one of the users (801-1, 801-2). In such aspect of the invention, the computing device (802) can detect the users (801-1, 801-2) and obtain a profile of each of the users (801-1, 801-2) from a memory. As described earlier, the profile includes interest of the user, multimedia settings, input setting, and other information pre-stored by the user and gathered by the computing device (802).

Upon receiving the input, the computing device (802) detects a plurality of webpages based on the interest corresponding to the users (801-1 and 802-2), and the input; and retrieves content from the detected plurality of webpages. Accordingly, FIG. 8b illustrates twelve web pages (803-1, 803-2, 803-3, 803-4, 803-5, 803-6, 803-7, 803-8, 803-9, 803-10, 803-11, and 803-12) detected by the computing device (802). Upon retrieving the content, the computing device (802) captures one or more portions from the retrieved content of the plurality of webpages based on the interest corresponding to the user and the user-input. Accordingly, FIG. 8b illustrates capturing of contents (804-1, 804-2, 804-3, 804-4, 804-5, 804-6, 804-7, 804-8, 804-9, 804-10, 804-11, and 804-12) from the detected webpages (803-1, 803-2, 803-3, 803-4, 803-5, 803-6, 803-7, 803-8, 803-9, 803-10, 803-11, and 803-12), as described earlier.

Upon capturing, the computing device (802) collates the captured portions of the plurality of webpages based on a set of criteria and creates a multimedia content based on the collation, as described earlier. In addition, the computing device (802) adds plurality of user-selectable task to the multimedia content.

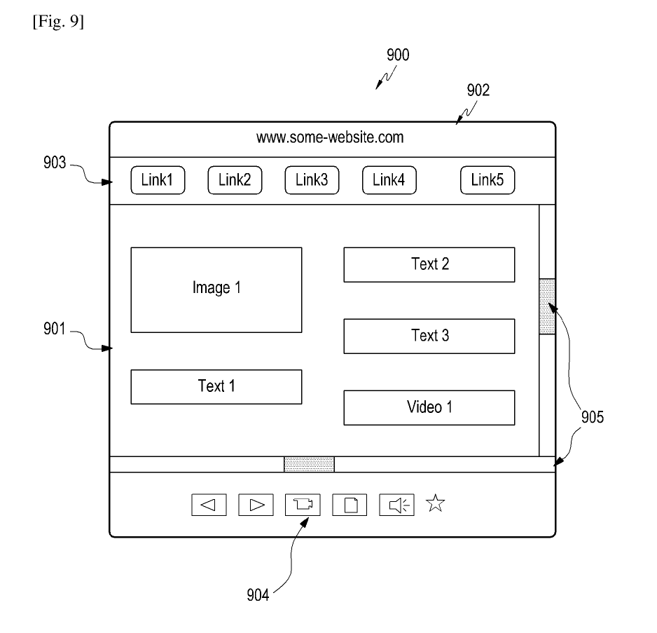

FIG. 9 illustrates an example presentation in form of a slide (900) for rendering the multimedia content corresponding to the first and second exemplary manifestations as described in reference to FIGS. 7 & 8 above. As described earlier, each slide corresponds to content captured from one of the detected webpages. Thus, the slide (900) includes content (901) captured from one of the detected webpages. The content includes text elements, video elements, image elements, and other links.

The slide (900) further includes a title (902) indicating a link of the detected webpage from where the content (901) was captured. The slide (900) further includes a fabricated menu (903). The fabricated menu (903) is composed of fixed menu options fetched from the detected webpage from where the content (901) was captured. Therefore, the fabricated menu (903) includes links, as available on the detected webpage to facilitate the user to find the desired link. Further, the slide (900) includes a plurality of user-selectable tasks (904) enabling the user to perform various tasks/functions on the slide (900). Examples of the plurality of user-selectable tasks (904) include, but not limited to, navigation between slides, volume, full screen, and mark contents.

Furthermore, the slide (900) includes a scroll mechanism (905) for scrolling through the slide (900). As would be understood, the scroll mechanism (900) is enabled when the content (901) exceeds window borders of the slide (900). Also, it would be understood, that the window borders of the slide (900) are dependent on a dimensions of a display unit of a computing device on which the slide (900) is presented.

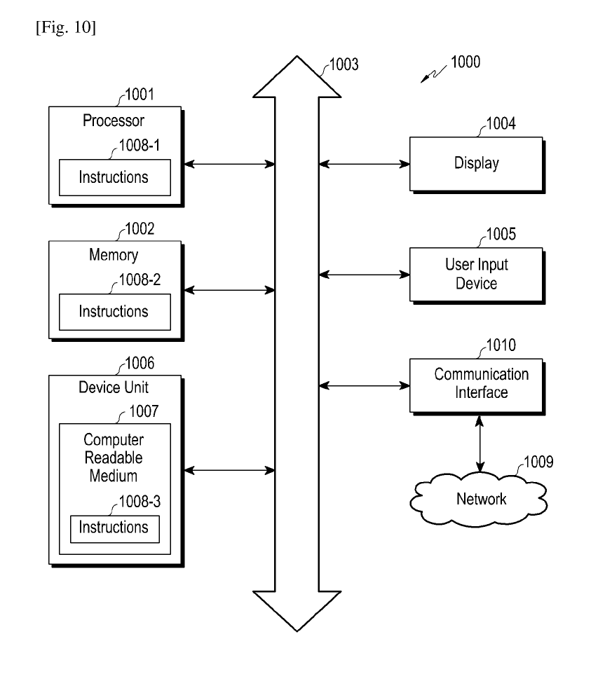

FIG. 10 illustrates a typical hardware configuration of a computing device (1000), which is representative of a hardware environment for implementing the present invention. As would be understood, the computing devices as described above, includes the hardware configuration as described below.

In a networked deployment, the computing device (1000) may operate in the capacity of a server or as a client user computer in a server-client user network environment, or as a peer computer system in a peer-to-peer (or distributed) network environment. The computing device (1000) can also be implemented as or incorporated into various devices, such as a personal computer (PC), a tablet PC, a personal digital assistant (PDA), a smart phone, a palmtop computer, a laptop, a desktop computer, and a communications device.

The computing device (1000) may include a processor (1001) e.g., a central processing unit (CPU), a graphics processing unit (GPU), or both. The processor (1001) may be a component in a variety of systems. For example, the processor (1001) may be part of a standard personal computer or a workstation. The processor (1001) may be one or more general processors, digital signal processors, application specific integrated circuits, field programmable gate arrays, servers, networks, digital circuits, analog circuits, combinations thereof, or other now known or later developed devices for analysing and processing data. The processor 1801 may implement a software program, such as code generated manually (i.e., programmed).

The computing device (1000) may include a memory (1002) communicating with the processor (1001) via a bus (1003). The memory (1002) may be a main memory, a static memory, or a dynamic memory. The memory (1002) may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory (1002) may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory (1002) is operable to store instructions executable by the processor (1001). The functions, acts or tasks illustrated in the figures or described may be performed by the programmed processor (1001) executing the instructions stored in the memory (1002). The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computing device (1000) may further include a display unit (1004), such as a liquid crystal display (LCD), an organic light emitting diode (OLED), a flat panel display, a solid state display, a cathode ray tube (CRT), or other now known or later developed display device for outputting determined information.

Additionally, the computing device (1000) may include an input device (1005) configured to allow a user to interact with any of the components of computing device (1000). The input device (1005) may be a number pad, a keyboard, a stylus, an electronic pen, or a cursor control device, such as a mouse, or a joystick, touch screen display, remote control or any other device operative to interact with the computing device (1000).

The computing device (1000) may also include a disk or optical drive unit (1006). The drive unit (1006) may include a computer-readable medium (1007) in which one or more sets of instructions (1008-3), e.g. software, can be embedded. In addition, instructions (1008-1, and 1008-2) may be separately stored in the processor (1001) and the memory (1002).

The computing device (1000) may further be in communication with other device over a network (1009) to communicate voice, video, audio, images, or any other data over the network (1009). Further, the data and/or the instructions (1008-1, 1008-2, 1008-3) may be transmitted or received over the network (1009) via a communication port or interface (1010) or using the bus (1003). The communication port or interface (1010) may be a part of the processor (1001) or may be a separate component. The communication port (1010) may be created in software or may be a physical connection in hardware. The communication port (1010) may be configured to connect with the network (1009), external media, the display (1004), or any other components in system (1000) or combinations thereof. The connection with the network (1009) may be a physical connection, such as a wired Ethernet connection or may be established wirelessly as discussed later. Likewise, the additional connections with other components of the system (1000) may be physical connections or may be established wirelessly. The network (1009) may alternatively be directly connected to the bus (1003).

The network (1009) may include wired networks, wireless networks, Ethernet AVB networks, or combinations thereof. The wireless network may be a cellular telephone network, an 802.11, 802.16, 802.20, 802.1Q or WiMax network. Further, the network (1009) may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the computing device (1000).

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computing device (1000) may be implemented by software programs executable by the processor (1001). Further, in a non-limited example, implementations can include distributed processing, component/object distributed processing, and parallel processing. Alternatively, virtual computer system processing can be constructed to implement various parts of the system.

The computing device (1000) is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. In addition, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While certain present preferred embodiments of the invention have been illustrated and described herein, it is to be understood that the invention is not limited thereto. Clearly, the invention may be otherwise variously embodied, and practiced within the scope of the following claims.

1. A method for auto-viewing of contents, the method comprising:
receiving an input for auto-viewing of contents;
detecting a plurality of webpages based on at least one of the input, pre-stored rules, and an user interest;
retrieving information from at least one of the plurality of webpages; and
creating a multimedia content based on the retrieved information for auto-viewing.

2. A method for creating a multimedia content, the method comprising:
receiving an input for creation of a multimedia content;
detecting a plurality of webpages based on at least one of the input and an user interest;
retrieving content from the detected plurality of webpages;
capturing one or more portions from the retrieved content of the plurality of webpages based on at least one of the input, the user interest, and pre-stored rules;
collating the one or more captured portions of the plurality of webpages based on a set of criteria; and
creating a multimedia content based on the collated one or more portions.

3. The method as claimed in claim 1, wherein the input includes one or more of: at least one keyword, at least one image, at least one webpage, one or more tabs currently active on a web browser, duration of the multimedia content, schedule of viewing the multimedia content, transition effect in the multimedia content, transition time in the multimedia content, transition pace in the multimedia content, theme of multimedia content, content generation command, and a combination of thereof.

4. The method as claimed in claim 3, wherein the input is received via one of: an input device, a non-touch gesture input, a touch gesture input, a voice input, and a text input.

5. The method as claimed in claim 2, before detecting the plurality of webpages, further comprising:
identifying a first set of webpages based on at least one of the input and the user interest; and
selecting the plurality of webpages from the first set of webpages based on at least one of a metadata associated with the first set of webpages and content of the first set of web page matching the input.

6. The method as claimed in claim 5, wherein the metadata associated with a webpage includes at least one of: page rank of the webpage, importance of the webpage, comment posted on the webpage, count of hits on the webpage, count of likes on the webpage, rating of the webpage, and rating of content available on the webpage.

7. The method as claimed in claim 1, wherein the user interest includes one or more of: browsing history, content viewing history, at least one pre-stored webpage, at least one keyword, and at least one pre-stored image.

8. The method as claimed in claim 7, wherein the browsing history includes one or more of: most-visited webpages, recently visited webpages, and corresponding extended webpages.

9. The method as claimed in claim 7, wherein the content viewing history includes one or more of: most-viewed content, last visited content, least visited content, unread content from the detected plurality of webpages, and un-visited content from the detected plurality of webpages.

10. The method as claimed in 2, wherein the set of criteria includes one or more of: update time, the user interest, priority, and un-visited content from the detected plurality of webpages.

11. The method as claimed in claim 10,
wherein the set of criteria further includes interest corresponding to a plurality of users, predefined order of interest corresponding to the plurality of users, and predefined percentage allocation of interest corresponding to the plurality of users, and
wherein the interest corresponding to the plurality of users includes one or more of: a combination of interest corresponding to each of the plurality of users, a combination of common interest corresponding to the plurality of users, and a selection of interest corresponding each of to the plurality of users.

12. The method as claimed in claim 2, wherein the one or more portions are captured based on one or more of: size of a display unit displaying the multimedia content, viewing distance of the display unit, font size of content of a webpage, viewing position of the display unit, probability of visibility of content of a webpage from the viewing position, and a further input.

13. The method as claimed in claim 2, before creating the multimedia content, further comprising one or more of:
adding at least one transition element to the multimedia content;
adding at least one media element to the multimedia content;
adding a authentication element to the multimedia content; and
applying a theme of content to the multimedia content.

14. A computing device for auto-viewing of contents, the computing device (300,400) comprising:
a receiving unit to receive an input for auto-viewing of contents;
a webpage detecting unit to detect a plurality of webpages based on at least one of the input, pre-stored rules, and an user interest;
a content selecting unit to retrieve information from at least one of the plurality of webpages; and
a multimedia content generating unit to create a multimedia content based on the retrieved information for auto-viewing.

15. A computing device for creating a multimedia content, the computing device (300,400) comprising:
a receiving unit to receive an input for creation of a multimedia content;
a webpage detecting unit to detect a plurality of webpages based on at least one of the user-input and an user interest;
a content selecting unit to:
retrieve content from the detected plurality of webpages; and
capture one or more portions from the retrieved content of the plurality of webpages based on at least one of the input, the user interest, and pre-stored rules; and
a multimedia content generating unit to:
collate the one or more captured portions of the plurality of webpages based on a set of criteria; and
create a multimedia content based on the collated one or more portions.

16. The method as claimed in claim 2, wherein the input includes one or more of: at least one keyword, at least one image, at least one webpage, one or more tabs currently active on a web browser, duration of the multimedia content, schedule of viewing the multimedia content, transition effect in the multimedia content, transition time in the multimedia content, transition pace in the multimedia content, theme of multimedia content, content generation command, and a combination of thereof

17. The method as claimed in claim 16, wherein the input is received via one of: an input device, a non-touch gesture input, a touch gesture input, a voice input, and a text input.

18. The method as claimed in claim 2, wherein the user interest includes one or more of: browsing history, content viewing history, at least one pre-stored webpage, at least one keyword, and at least one pre-stored image.

19. The method as claimed in claim 18, wherein the browsing history includes one or more of: most-visited webpages, recently visited webpages, and corresponding extended webpages.

20. The method as claimed in claim 18, wherein the content viewing history includes one or more of: most-viewed content, last visited content, least visited content, unread content from the detected plurality of webpages, and un-visited content from the detected plurality of webpages.
